(19) United States
(12) Patent Application Publication
(10) Pub. No.: US 2026/0023049 A1
(43) Pub. Date: Jan. 22, 2026

(54) Detection method for internal defects of plastic encapsulated components

(71) Applicant: Tianjin University, Tianjin (CN)

(72) Inventors: Yuye WANG, Tianjin (CN); Degang XU, Tianjin (CN); Chunhui LI, Tianjin (CN); Kai CHEN, Tianjin (CN); Kai ZHONG, Tianjin (CN); Jining LI, Tianjin (CN); Jianquan YAO, Tianjin (CN)

(73) Assignee: Tianjin University, Tianjin (CN)

(21) Appl. No.: 18/820,308

(22) Filed: Aug. 30, 2024

(30) Foreign Application Priority Data
Jul. 16, 2024 (CN) 202410952283.3

(51) Int. Cl. G01N 29/44; G01N 29/24

(52) U.S. Cl. CPC G01N 29/4409; G01N 29/2418; G01N 29/4445

(57) ABSTRACT

A detection method for internal defects of plastic encapsulated components includes the following steps: pretreatment of plastic encapsulated components; photoacoustic signal acquisition; time domain waveform extraction, and analysis. In the detection method for internal defects of plastic encapsulated components, the photoacoustic image of different plastic encapsulated components is measured by the photoacoustic detection system based on the photoacoustic effect, and the time-domain waveforms at different positions of plastic encapsulated components along the laser and ultrasonic propagation directions are extracted. By analyzing the position, shape, and strength characteristics of the reflection peak of the time-domain waveform, the identification, positioning, and defect type analysis of the internal defects of plastic encapsulated components are realized, the photoacoustic effect is used to distinguish the defect area and defect type inside the plastic encapsulated components, which provides a new method for the non-destructive testing of the internal defects of plastic encapsulated components.

### CROSS REFERENCE TO THE RELATED APPLICATIONS

This application is based upon and claims priority to Chinese Patent Application No. 202410952283.3, filed on Jul. 16, 2024, the entire contents of which are incorporated herein by reference.

### TECHNICAL FIELD

The invention relates to the field of defect detection technology, particularly a detection method for internal defects of plastic encapsulated components.

### BACKGROUND

The chip needs to be packaged during processing to facilitate use and maintenance. At present, plastic packaging is the mainstream process used in the integrated circuit market because of its low cost, simple process, and suitability for mass production, the operation of plastic packaging is to put the chip and other components into the plastic packaging mold, and pour into the plastic packaging material such as epoxy resin, and then put the mold into the high temperature and high-pressure hot press, so that the plastic packaging material is deformed and tightly sealed chip and wire. Because this packaging method is a non-airtight packaging, the packaged plastic components are prone to internal defects, which reduces their reliability, therefore, internal defect detection before the use of plastic components is the key to ensuring the long-term and efficient operation of the device.

Currently, the internal defect detection technology of plastic encapsulated components mainly comprises X-ray and ultrasonic detection technology. X-ray detection technology has a high detection rate for volume defects such as pores and slag inclusions, and the defect display method can be directly observed by the film, but this method cannot detect defects such as delamination in the vertical irradiation direction. In addition, the method is costly and harmful to the human body. Ultrasonic testing technology is sensitive to defects caused by air, has good penetration, and is harmless to the human body, however, it needs to soak the object to be tested in a coupling agent such as water, which requires subsequent drying of plastic components to avoid secondary damage, and the imaging resolution is low.

Photoacoustic detection technology based on the photoacoustic effect is a new type of non-destructive testing technology, its basic principle is that when periodic modulated light or pulsed light is irradiated on the material to be tested, the material to be tested absorbs light energy and is periodically heated to produce pressure waves, that is, photoacoustic signals. Because the transverse range of the generated ultrasonic signal depends on the size of the laser spot, compared with the ultrasonic detection technology, the photoacoustic detection technology can have higher lateral resolution in the case of strong focusing of the laser, about 1 μm to 100 μm; and because the detection results are also affected by the optical absorption characteristics of the object to be tested, the photoacoustic detection has a higher imaging contrast than the ultrasonic detection using only ultrasound. Considering that the ultrasonic wave generated by the photoacoustic effect is transmitted in the object to be tested, it is very sensitive to the defects caused by the internal air of the object to be tested, but the photoacoustic detection only needs a layer of ultrasonic coupling agent on the surface of the object to be tested, which avoids the secondary damage or subsequent processing caused by the immersion of the sample, and has the advantages of non-destructive, real-time, fast and high sensitivity. Therefore, photoacoustic detection technology based on the photoacoustic effect has great application prospects and application value in the internal defects of plastic components.

### SUMMARY

The purpose of the invention is to provide a detection method for internal defects of plastic encapsulated components, which solves the problems raised in the above background technology, by extracting and comparing the time-domain waveforms at different locations on the surface of plastic encapsulated components, the location, shape, and strength characteristics of the time-domain waveforms are analyzed, and the location, size, and type of internal defects of plastic encapsulated components are determined.

In order to achieve the above purpose, the invention provides a detection method for internal defects of plastic encapsulated components, comprising the following steps:
Step 1: pretreatment of plastic encapsulated component: dropping coupling agent on a surface of a plastic encapsulated component;
Step 2: photoacoustic signal acquisition: placing pre-treated plastic encapsulated components on a test platform, and obtaining original data by photoacoustic scanning detection of the plastic encapsulated component;
Step 3: time-domain waveform extraction and analysis: extracting the time-domain waveform at different locations on the surface of the plastic encapsulated component, and a value of the data represents a strength of the ultrasonic signal to be measured; by comparing time-domain waveform data, judging whether the component has a defect according to abnormal location, shape and strength characteristics of the time-domain waveform, if there are defects, further obtaining a location of the defect.

Preferably, the coupling agent covering the surface of the plastic encapsulated component in Step 1 is ultra-pure water or glycerin, placing the ultra-pure water or glycerin in an ultrasonic vibration device to exclude bubbles and then using the ultra-pure water or glycerin to ensure that there is no bubble between an ultrasonic probe and the plastic encapsulated component during a detection process.

Preferably, collecting the photoacoustic signal by a photoacoustic detection system in Step 2, the photoacoustic detection system comprises a nanosecond laser source, injecting a nanosecond laser beam of the nanosecond laser source on a laser reflector through the optical path system, and approaching the ultrasonic probe and a reflected laser beam to each other, placing the laser reflector and the ultrasonic probe on a side of a voice coil motor, the voice coil motor is used for scanning control to realize a laser scanning on a surface of a sample to be tested, focusing and irradiating the laser to excite the ultrasonic signal on the surface of the sample to be tested, transmitting the ultrasonic signal forward in the plastic encapsulated component, when interface, bubble, or a cavity defect is encountered, returning an ultrasonic signal to be measured by the ultrasonic probe;
a wavelength of the nanosecond laser source is set to 532 nm or 556 nm, and a single pulse energy and a peak power density will not cause damage to the surface of the object to be tested, and a repetition frequency is 1 kHz;
a center frequency of the ultrasonic probe is 60 MHz.

Preferably, specific steps of Step 3 comprise:
Step S31, obtaining each column of data along a direction of laser and ultrasonic propagation;
Step S32, extracting the time-domain waveform at different locations on the surface of the plastic encapsulated component, and comparing and analyzing the location, shape strength characteristics of a time-domain waveform reflection peak, etc., an abnormal location region of the waveform represents a defect region, which can distinguish a normal region and the defect region, determining the location of the defect according to the location of an abnormal value in the time-domain waveform, comprising a defect depth and a plane coordinate;
Step S33, mapping location information to a two-dimensional plan to form an x-y plane diagram and an x-z profile diagram, obtaining a two-dimensional photoacoustic image showing the location, size, and shape of the defect, and determining a defect type.

Preferably, a tested component refers to one of the plastic encapsulated components completed by epoxy resin packaging, silicone packaging, ceramic packaging, glass packaging, and metal packaging.

Preferably, in Step S32, obtaining a photoacoustic signal under excitation of pulse energy of δ(t) by a photoacoustic equation to analyze the time-domain waveform of the normal region and the defect region, the expression is as follows:

$$p ( \vec{r} , t ) = \frac{1}{4 π {v}_{s}^{2}} \frac{\partial }{\partial t} [ \frac{1}{{v}_{s} t} \int d {\vec{r}}^{′} {p}_{0} ( {\vec{r}}^{′} ) δ ( t - \frac{\vert \vec{r} - {\vec{r}}^{′} \vert}{{v}_{s}} ) ]$$

where vₛ is a transmission speed of an ultrasonic wave in a medium, p(r, t) is a photoacoustic pressure at location r inside the object to be measured at time t, p₀(r′) is the photoacoustic pressure at a certain location of a sound source, δ(t) is an impulse function, it is used to represent a laser pulse, ∂ is a partial derivative symbol.

Preferably, a formula for calculating the defect depth in Step S32 is as follows:

$$d = \frac{N \times {v}_{s}}{2 {f}_{s}}$$

where d is a defect depth, vₛ is a transmission speed of the ultrasonic wave in the medium, N is a number of sampling points in the z-axis direction, and fₛ is a sampling frequency.

Therefore, the invention adopts the above-mentioned detection method for internal defects of plastic encapsulated components, which has the following beneficial effects:

(1) The invention uses a photoacoustic effect to realize the internal defect detection of plastic encapsulated components, which has the advantages of being non-destructive, real-time, and fast.

(2) The invention only needs to drop ultra-pure water on the surface of the plastic encapsulated component to form a water film, which has the advantages of simple operation, and avoids the disadvantages of secondary damage to the sample and complicated subsequent operation, and saves time cost.

(3) The defect location is determined by analyzing the time-domain waveform of the photoacoustic effect, and the size and type of the defect are determined by combining the two-dimensional photoacoustic plane image and the profile image, the invention has the advantages of safety and high sensitivity, and provides a new detection technology for the internal defect detection of plastic encapsulated components.

The following is a further detailed description of the technical scheme of the invention through drawings and an embodiment.

### BRIEF DESCRIPTION OF THE DRAWINGS

FIG. 1 is a structural schematic diagram of the photoacoustic detection system in the embodiment of the above-mentioned detection method for internal defects of plastic encapsulated components.

FIGS. 2A-2B are time-domain waveforms of photoacoustic detection of plastic encapsulated components, where FIG. 2A is a time-domain waveform with defects; FIG. 2B is a time-domain waveform of the normal location;

FIGS. 3A-3B are photoacoustic time-domain waveforms of the normal region and the defect region of typical plastic encapsulated components, where FIG. 3A is the overall waveform; FIG. 3B is the detailed enlarged figure;

FIGS. 4A-4B are photoacoustic images of typical plastic encapsulated components with defects, where FIG. 4A is an x-y plane diagram; FIG. 4B is an x-z profile diagram;

FIGS. 5A-5B are photoacoustic images of typical normal plastic encapsulated components, where FIG. 5A is an x-y plane diagram; FIG. 5B is an x-z profile diagram;

Marks in the figures: 1, control computer; 2, nanosecond laser source; 3, optical path system; 4, laser reflector; 5, voice coil motor; 6, ultrasonic probe; 7, ultrasonic signal; 8, plastic encapsulated component; 9, ultra-pure water film.

### DETAILED DESCRIPTION OF THE EMBODIMENTS

The following is a further explanation of the technical scheme of the invention through drawings and an embodiment.

Unless otherwise defined, the technical terms or scientific terms used in the invention should be understood by people with general skills in the field to which the invention belongs, the words ‘first’, ‘second’, and the like used in this invention do not represent any order, quantity, or importance, but are only used to distinguish different components, similar words such as ‘comprise’ or ‘comprising’ mean that the elements or objects appearing before the word cover the elements or objects listed after the word and their equivalents, without excluding other elements or objects, similar terms such as ‘connected’ or ‘connecting’ are not limited to physical or mechanical connections, but can comprise electrical connections, whether direct or indirect. ‘Up’, ‘down’, ‘left’, ‘right’, etc. are only used to represent the relative locational relationship, when the absolute location of the described object changes, the relative locational relationship may also change accordingly.

### EMBODIMENT

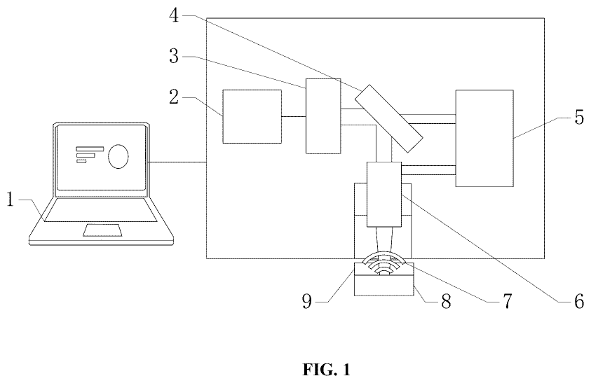

Refer to FIGS. 1-5B, the invention provides a detection method for internal defects of plastic encapsulated components, comprising the following steps:

Step 1: Pretreatment of plastic encapsulated component 8: The coupling agent is dropped on the surface of plastic encapsulated component 8. The plastic encapsulated component 8 used in the test is one of the plastic encapsulated components 8 completed by epoxy resin packaging, silicone packaging, ceramic packaging, glass packaging, and metal packaging. The coupling agent covering the surface of the plastic encapsulated component 8 is ultra-pure water or glycerin or other coupling agents, which is used to ensure that there is no bubble between the ultrasonic probe 6 and the plastic encapsulated component 8 during the detection process. The coupling agent such as ultra-pure water or glycerol is placed in the ultrasonic vibration device to eliminate the bubbles in the coupling agent and then used. The coupling agent used in this implementation is ultra-pure water. First, ultra-pure water needs to be added dropwise on the surface of the plastic encapsulated component 8 to form a layer of ultra-pure water film 9, so that when the surface of the ultrasonic probe 6 contacts with the plastic encapsulated component 8, the ultra-pure water can be completely covered on the surface of the plastic encapsulated component 8, so as to avoid the generation of bubbles during the contact process and ensure that there are no bubbles on the surface of the plastic encapsulated component 8 to be tested.

Step 2: Photoacoustic signal acquisition: The pre-treated plastic encapsulated component 8 is placed on the test platform, and the photoacoustic scanning detection of the plastic encapsulated component 8 is performed to obtain the original data. Photoacoustic image signal acquisition is performed by a photoacoustic detection system, as shown in FIG. 1, the photoacoustic detection comprises the nanosecond laser source 2. The wavelength of nanosecond laser source 2 is set to 532 nm or 556 nm, and the single pulse energy and peak power density will not cause damage to the surface of the object to be measured, the single pulse energy is not higher than 50 μJ and the repetition frequency is 1 kHz.

The rear of the nanosecond laser source 2 is equipped with an optical path system 3, a laser reflector 4, and an ultrasonic probe 6. The center frequency of the ultrasonic probe 6 is 60 MHz. The nanosecond laser beam of nanosecond laser source 2 is injected into the laser reflector 4 through the optical path system 3, and the ultrasonic probe 6 is close to the reflected laser beam, the laser reflector 4 and the ultrasonic probe 6 are placed on the side of the voice coil motor 5, the voice coil motor 5 is used for scanning control to realize the laser scanning on the surface of the sample to be tested. After the laser is focused, it is irradiated on the surface of the sample to be tested to excite the ultrasonic signal 7, the ultrasonic signal 7 is transmitted forward in the plastic encapsulated component 8, when the interface, bubble, or a cavity defect is encountered, the ultrasonic signal 7 is returned and measured by the ultrasonic probe 6. The photoacoustic detection system and the control computer 1 are connected by a data transmission line.

The specific steps of photoacoustic signal acquisition comprise: (1) After preprocessing, photoacoustic scanning is performed, firstly, the location of the stage is adjusted to ensure that the surface of the plastic encapsulated component 8 is horizontal and the upper surface is in the laser focusing location; (2) According to the size of the plastic encapsulated component 8, the transverse sampling step of the probe is set to 15 μm, and the scanning region is set to a square region with a side length of 9 cm.

Step 3: Time-domain waveform extraction and analysis: The time-domain waveforms at different locations are extracted on the surface of the plastic encapsulated component 8, and the size of the data value represents the strength of the ultrasonic signal 7 to be measured; by comparing the time-domain waveform data, the device is judged to have defects according to the abnormal location, shape and strength characteristics of the time-domain waveform, if there are defects, the location of the defect is further obtained. The specific steps of the above step three comprise:

Step S31, in the original data processing, the programming software is used on the control computer 1, such as Matlab, etc., to directly extract the one-dimensional data, and then transform it into a three-dimensional data matrix by reshaping. Each column of time-domain wavelength data along the direction of laser and ultrasonic propagation in the three-dimensional data matrix is obtained.

Step S32, the time-domain waveforms in the z-axis direction at different locations on the surface of the plastic-encapsulated component 8 along the direction of laser and ultrasonic propagation are extracted, since the data results of photoacoustic detection contains depth information, the value of each point reflects the intensity of the photoacoustic signal, therefore, the graph drawn along the z-axis direction is a time-domain waveform. The location, shape, and strength characteristics of the time-domain waveform reflection peak are compared and analyzed, firstly, according to the shape of the waveform, it is judged whether there are defects inside the plastic encapsulated component 8, if there are defects, the normal region and the defect region are distinguished, the abnormal location region of the waveform represents the defect region. According to the location of the abnormal value in the time-domain waveform, the location of the defect is determined, comprising the defect depth and the plane coordinate.

Step S33, the location information is mapped to a two-dimensional plane diagram, and two photoacoustic images of the x-y plane diagram and x-z profile diagram are drawn, the depth information obtained by the time-domain waveform is used to locate the defect, and the two-dimensional photoacoustic image showing the location, size, and shape of the defect is obtained to determine the type of defect.

The time-domain waveforms of the normal region and the defect region are analyzed by the photoacoustic signal excited by the pulse energy through the photoacoustic equation. The expression is as follows:

$$p ( \vec{r} , t ) = \frac{1}{4 π {v}_{s}^{2}} \frac{\partial }{\partial t} [ \frac{1}{{v}_{s} t} \int d {\vec{r}}^{′} {p}_{0} ( {\vec{r}}^{′} ) δ ( t - \frac{\vert \vec{r} - {\vec{r}}^{′} \vert}{{v}_{s}} ) ]$$

where vₛ is the transmission speed of the ultrasonic wave in the medium, p(r, t) is the photoacoustic pressure at location r inside the object to be measured at time t, p₀(r′) is the photoacoustic pressure at a certain location of the sound source, δ(t) is the impulse function, it is used to represent a laser pulse, @ is the partial derivative symbol.

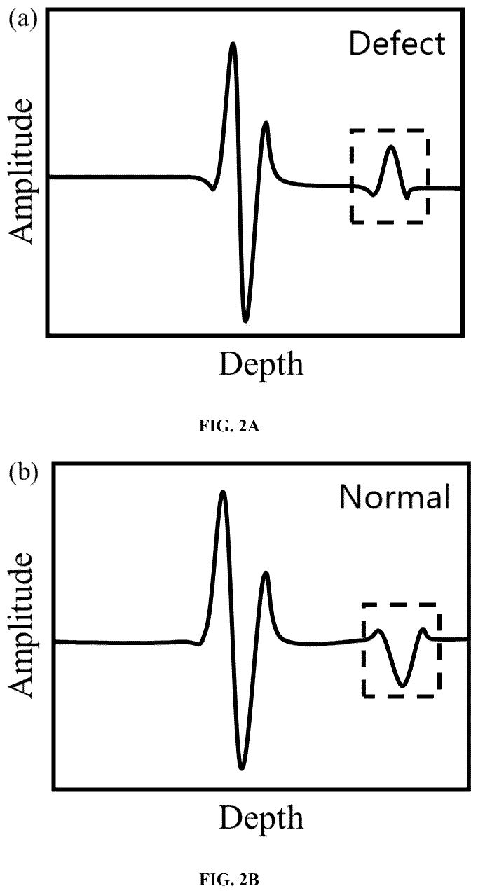

In the above expression, the signal amplitude is mainly related to the sound velocity, when there are defects in the original part to be tested, it is generally considered that there are bubbles inside, and the medium of ultrasonic propagation is from epoxy resin to air and then to epoxy resin, monocrystalline silicon or metal pin, at this time, the sound velocity of the medium decreases first and then increases, and the corresponding signal amplitude will increase first and then decrease, as shown in the signal in the dotted box in FIG. 2A. When there is no defect in the original part to be tested, the first case is that the medium does not change, the sound speed is constant, the ultrasonic wave does not reflect at this time, and the time-domain waveform will also not appear reflected signal. The second case is to detect other materials inside the medium, for example, the plastic chip will mainly detect monocrystalline silicon or metal pins, and the medium of ultrasonic propagation is from epoxy resin to monocrystalline silicon or metal to epoxy resin. At this time, the sound speed of the medium increases first and then decreases, and the corresponding signal amplitude decreases first and then increases, as shown in the signal in the dotted box in FIG. 2B. The first reflection signal in FIG. 2A and FIG. 2B is the reflection signal caused by the ultrasonic wave entering the surface of epoxy resin material from water.

The calculation formula for defect depth is as follows:

$$d = \frac{N \times {v}_{s}}{2 {f}_{s}}$$

where d is the defect depth, vₛ is the transmission speed of the ultrasonic wave in the medium, N is the number of sampling points in the z-axis direction, and fₛ is the sampling frequency. Since the probe of the photoacoustic detection system receives the reflected signal, the detected photoacoustic signal is transmitted according to the path of ‘generation→transmission in the medium→detection of defects→reflecting back to the probe’, so the denominator is divided by 2 when the defect depth is calculated. In the actual detection system, the number of sampling points in the z-axis direction is 1280, and the sampling frequency is 500 MHz.

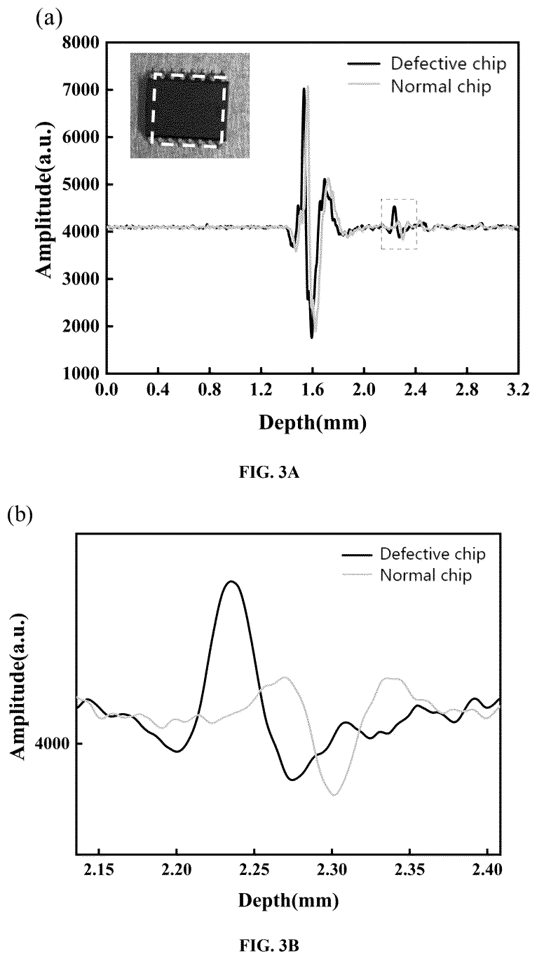

This embodiment is based on the detection results of a plastic encapsulated component 8 with internal defects and a normal plastic encapsulated component 8 based on photoacoustic imaging, the two components are the same type of devices with the same size. The length, width, and height of the epoxy resin encapsulation region are 10.43 mm, 7.41 mm, and 2.19 mm, respectively, the physical image is shown in FIG. 3A. The test region is shown in the dotted box region in the figure.

FIG. 3A is the time-domain waveform of defect detection of the plastic encapsulated component 8 based on photoacoustic imaging. From the diagram, it can be seen that the reflection signal in the depth range of 1.38-1.87 mm comes from the reflection of the upper surface of the plastic encapsulated component 8; a second reflection signal appears in the depth range of 2.20-2.35 mm, and the waveform is different. The second reflected signal in FIG. 3A is amplified, as shown in FIG. 3B. It can be seen from the figure that the time-domain waveform represented by the light gray curve shows a reflection signal in the depth range of 2.25-2.35 mm, and the reflection signal intensity decreases first and then increases, which is caused by the incident of the ultrasonic wave from epoxy resin to encapsulated monocrystalline silicon; the time-domain waveform represented by the black curve shows an abnormal reflection signal in the depth range of 2.20-2.30 mm, the intensity of the reflected signal increases first and then decreases, which is caused by the incident of ultrasonic wave from epoxy resin to internal bubbles. Because the acoustic impedance of air is smaller than that of epoxy resin, and the acoustic impedance of monocrystalline silicon is larger than that of epoxy resin, the waveform of the reflection peak caused by the defect region and the normal region inside the plastic encapsulated component 8 shows the opposite shape, the waveform of the defect region shows a waveform that increases first and then decreases (also known as a positive peak), and the waveform of the normal region shows a waveform that decreases first and then increases (also known as a negative peak).

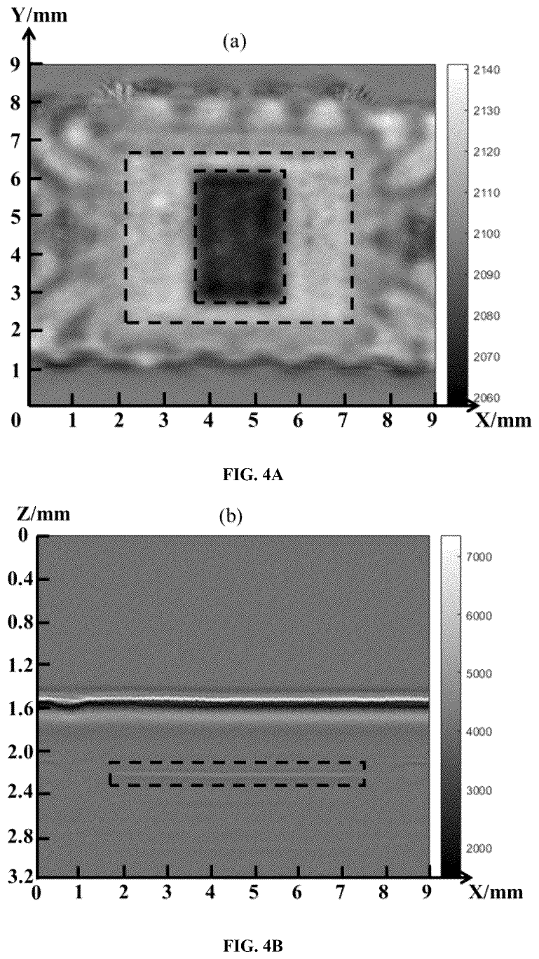

According to the photoacoustic time-domain waveform data, the x-y plane diagram and the x-z profile diagram are drawn. FIGS. 4A-4B are photoacoustic images of defective plastic encapsulated component 8. Considering that the defect depth presented in FIGS. 3A-3B is about 2.25 mm, FIG. 4A is the x-y photoacoustic plane diagram with a depth of 2.2-2.3 mm. From the diagram, it can be seen that there are obvious abnormal regions around the chip in the photoacoustic image, as shown in the part surrounded by the dotted wire frame, which can determine the size and range of the defect on the x-y plane diagram. FIG. 4B is the x-z photoacoustic profile when the y coordinate is at 6.72 mm, and the dotted box is the defect location, so the size and range of the defect in the x-z plane can be determined. Combined with the waveform analysis, the defect location on the waveform is close to the reflected signal location of the normal component, and it can be seen from the x-y image that the defect is located around the chip. From the x-z image, it can be seen that the defect shape is a layered defect, and the defect type is fully surrounded and layered, which indicates that the photoacoustic detection technology can complete the positioning and type judgment of the internal defects of the plastic encapsulated component 8.

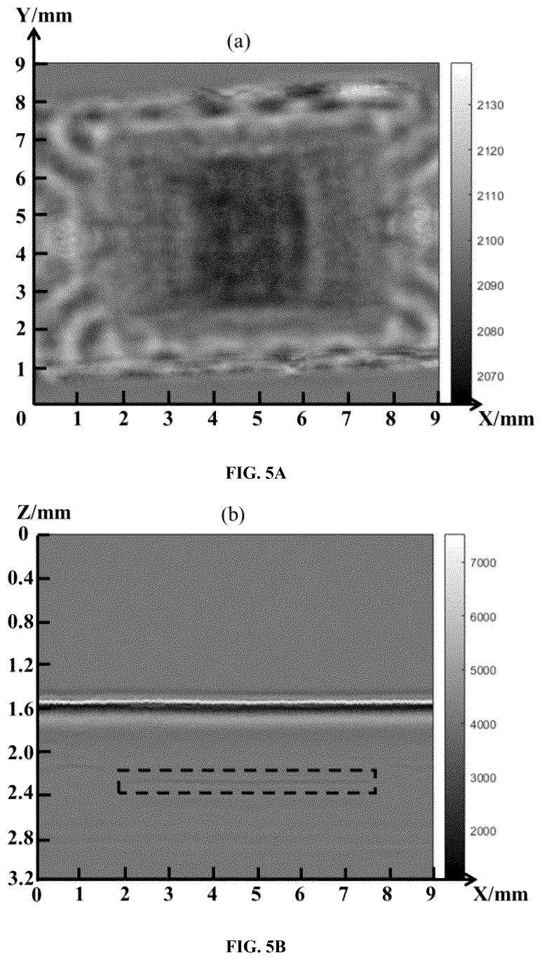

FIGS. 5A-B are photoacoustic images of normal plastic encapsulated component 8. Considering that the depth of the chip presented in FIGS. 3A-3B is about 2.3 mm, FIG. 5A is the x-y photoacoustic plane at the depth of 2.25-2.35 mm, compared with FIG. 4A, there is no obvious abnormal region around the central chip. FIG. 5B is the x-z photoacoustic profile when the y coordinate is at 6.54 mm. Compared with FIG. 4B, the image at the dotted box in FIG. 5B is obviously different, which indicates that the photoacoustic detection technology can realize the identification, location, and defect type analysis of the internal defects of plastic encapsulated components 8.

Therefore, this invention adopts the above detection method for internal defects of plastic encapsulated components and uses the photoacoustic detection system based on the photoacoustic effect to measure the photoacoustic images of different plastic encapsulated components. The time-domain waveforms at different locations of plastic encapsulated components along the direction of laser and ultrasonic propagation are extracted, by analyzing the location, shape, and strength characteristics of the reflection peak of the time-domain waveform, the identification, location, and defect type analysis of the internal defects of plastic encapsulated components are realized, the photoacoustic effect is used to distinguish the defect region and defect type inside the plastic encapsulated components, which provides a new method for the non-destructive detection of the internal defects of plastic encapsulated components, it is of great significance to improve the reliability of plastic components.

Finally, it should be explained that the above embodiment is only used to explain the technical scheme of the invention rather than restrict it, although the invention is described in detail concerning the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. A detection method for an internal defect of a plastic encapsulated component, comprising the following steps:
step 1: pretreatment of the plastic encapsulated component: dropping a coupling agent on a surface of the plastic encapsulated component;
step 2: photoacoustic signal acquisition: placing the plastic encapsulated component after pretreatment on a test platform, and obtaining original data by photoacoustic scanning detection of the plastic encapsulated component; and
step 3: time-domain waveform extraction and analysis: extracting a time-domain waveform at different locations on the surface of the plastic encapsulated component, wherein a size of a data value represents a strength of an ultrasonic signal to be measured; by comparing time-domain waveform data, judging if the plastic encapsulated component has a defect according to abnormal location, shape and strength characteristics of the time-domain waveform, if there exists a defect, further obtaining a location of the defect.

2. The detection method for the internal defect of the plastic encapsulated component according to claim 1, wherein the coupling agent covering the surface of the plastic encapsulated component in step 1 is ultra-pure water or glycerin, wherein the ultra-pure water or glycerin is placed in an ultrasonic vibration device to exclude bubbles and then used to ensure that there is no bubble between an ultrasonic probe and the plastic encapsulated component during a detection process.

3. The detection method for the internal defect of the plastic encapsulated component according to claim 2, wherein a photoacoustic signal is collected by a photoacoustic detection system in step 2, and the photoacoustic detection system comprises a nanosecond laser source, wherein a nanosecond laser beam of the nanosecond laser source is injected on a laser reflector through an optical path system, the ultrasonic probe and a reflected laser beam approach to each other, the laser reflector and the ultrasonic probe are placed on a side of a voice coil motor, the voice coil motor is used for scanning control to realize a laser scanning on a surface of a sample to be tested, the laser is focused and irradiated to excite an ultrasonic signal on the surface of the sample to be tested, the ultrasonic signal is transmitted forward in the plastic encapsulated component, and when interface, bubble and cavity defects are encountered, the ultrasonic signal is returned to be measured by the ultrasonic probe;
a wavelength of the nanosecond laser source is set to 532 nm or 556 nm, and a single pulse energy and a peak power density do not cause damage to the surface of the sample to be tested, and a repetition frequency is 1 kHz; and
a center frequency of the ultrasonic probe is 60 MHz.

4. The detection method for the internal defect of the plastic encapsulated component according to claim 3, wherein the step 3 comprises:
step S31, obtaining each column of data along a direction of laser and ultrasonic propagation;
step S32, extracting the time-domain waveform at different locations on the surface of the plastic encapsulated component, and comparing and analyzing location, shape, and strength characteristics of a time-domain waveform reflection peak, wherein an abnormal location region of the time-domain waveform represents a defect region, and a normal region and the defect region are distinguished; determining a location of the defect according to a location of an abnormal value in the time-domain waveform, comprising a defect depth and a plane coordinate; and
step S33, mapping location information to a two-dimensional plan to form an x-y plane diagram and an x-z profile diagram, obtaining a two-dimensional photoacoustic image showing the location, size, and shape of the defect, and determining a defect type.

5. The detection method for the internal defect of the plastic encapsulated component according to claim 4, wherein the plastic encapsulated component is completed by one selected from the group consisting of epoxy resin packaging, silicone packaging, ceramic packaging, glass packaging, and metal packaging.

6. The detection method for the internal defect of the plastic encapsulated component according to claim 5, wherein in step S32, the photoacoustic signal under an excitation of pulse energy of δ(t) is obtained by a photoacoustic equation to analyze the time-domain waveform of the normal region and the defect region, wherein an expression is as follows:
$$p ( \vec{r} , t ) = \frac{1}{4 π {v}_{s}^{2}} \frac{\partial }{\partial t} [ \frac{1}{{v}_{s} t} \int d {\vec{r}}^{′} {p}_{0} ( {\vec{r}}^{′} ) δ ( t - \frac{\vert \vec{r} - {\vec{r}}^{′} \vert}{{v}_{s}} ) ]$$
where vₛ is a transmission speed of an ultrasonic wave in a medium, p(r, t) is a photoacoustic pressure at location r inside the sample to be measured at time t, p₀(r′) is the photoacoustic pressure at a certain location of a sound source, δ(t) is an impulse function and is used to represent a laser pulse, and ∂ is a partial derivative symbol.

7. The detection method for the internal defect of the plastic encapsulated component according to claim 6, wherein a formula for calculating the defect depth in step S32 is as follows:
$$d = \frac{N \times {v}_{s}}{2 {f}_{s}}$$
wherein d is the defect depth, vₛ is the transmission speed of the ultrasonic wave in the medium, N is a number of sampling points in a z-axis direction, and fₛ is a sampling frequency.
